(19) United States
(12) Patent Application Publication
(10) Pub. No.: US 2013/0263429 A1
(43) Pub. Date: Oct. 10, 2013

(54) CAULKING JOINT METHOD AND CAULKING JOINT STRUCTURE

(71) Applicants: DENSO CORPORATION, Kariya-city (JP); ADVICS CO., LTD., Kariya-city (JP)

(72) Inventors: Fumitoshi Koyama, Kariya-shi (JP); Kenji Murakami, Chiryu-shi (JP)

(73) Assignees: ADVICS CO., LTD., Kariya-city (JP); DENSO CORPORATION, Kariya-city (JP)

(21) Appl. No.: 13/833,701

(22) Filed: Mar. 15, 2013

(30) Foreign Application Priority Data
Apr. 4, 2012 (JP) 2012-085265

(51) Int. Cl. B21D 39/04; F16L 13/14

(52) U.S. Cl. CPC B21D 39/046; F16L 13/14
USPC 29/511; 285/382

(57) ABSTRACT

A part of a bottom of a flange insertion hole that faces a flange part has a form in which an outer circumference side is nearer to the flange part than an inner circumference side. According to this, since a rounded surface of a perimeter edge of the flange part can easily contact to the bottom of the flange insertion hole, an area that receives caulking load is larger as compared with a case where only a flat surface of the flange part contacts the bottom of the flange insertion hole as before, therefore, the bottom of the flange insertion holes can be prevented from buckling.

### CROSS-REFERENCE TO RELATED APPLICATION

The application is based on and claims the benefit of priority from earlier Japanese Patent Application No. 2012-85265 filed Apr. 4, 2012, the description of which is incorporated herein by reference.

### TECHNICAL FIELD

The present disclosure relates to a caulking joint method that joins two components by caulking, and a caulking joint structure.

### BACKGROUND

An ABS (anti-lock brake system), for example, that avoids tendency of wheels to lock by increasing and decreasing a brake fluid pressure in vehicles is known.

In an actuator of the ABS, a fluid passage where brake fluid flows is formed in a housing, and the fluid passage is opened and closed by an electromagnetic valve.

Then, a main valve part (specifically, a portion except for a coil section) of the electromagnetic valve is joined to the housing by caulking (or crimping) the housing after inserting the main valve part into a hole formed in the housing.

In detail, a guide in the main valve part has a flange part on a perimeter, and the housing has a flange insertion hole where the flange part is inserted.

The main valve part and the housing are joined by applying caulking load around the flange insertion hole in the state where one end surface of the flange part is contacted on a bottom of the flange insertion hole, so that a portion around the flange insertion hole is plastic-deformed so as to cover another end surface of the flange part (refer to Japanese Patent Application Laid-Open Publication No. 2012-26466, for example).

However, when the one end surface of the flange ₚart is contacted on the bottom of the flange insertion hole, a rounded surface of a perimeter edge of the flange part does not contact the bottom of the flange insertion hole, an area that receives caulking load decreases.

Therefore, when caulking the housing, the bottom of the flange insertion hole can become buckled, and there is a problem that a positional relationship between the main valve part of the electromagnetic valve and the housing varies.

Moreover, the guide is processed by forging in recent years, and since the rounded surface of the perimeter edge of the flange part becomes larger than a case where the guide is processed by machining, the problem mentioned above becomes more remarkable.

Incidentally, when the bottom of the flange insertion hole is buckled, the main valve part of the electromagnetic valve enters deeply in the housing.

As a result, the positional relationship between the main valve part and the coil varies, and thus attraction power of the electromagnetic valve also varies.

### SUMMARY

An embodiment provides a caulking joint method and a caulking joint structure that prevent a bottom of a flange insertion hole from buckling when joining two components by caulking.

In a caulking joint method according to a first aspect, the method for joining a first component made of metal that has a flange part on a perimeter and a second component made of metal that has a flange insertion hole where the flange part is inserted includes steps of forming a part of a bottom of the flange insertion hole that faces the flange part in which an outer circumference side is nearer to the flange part than an inner circumference side, contacting one end surface of the flange part to the bottom of the flange insertion hole, and applying caulking load around the flange insertion hole for plastic-deforming a portion around the flange insertion hole to cover another end surface of the flange part.

Accordingly, since a rounded surface of a perimeter edge of the flange part can easily contact to the bottom of the flange insertion hole, an area that receives caulking load is increased relative to the prior art and the bottom of the flange insertion hole is prevented from being buckled.

In the caulking joint method according to a second aspect, the part of the bottom of the flange insertion hole that faces the flange part is formed into a stepped shape.

In the caulking joint method according to a third aspect, the part of the bottom of the flange insertion hole that faces the flange part is formed into a curved shape.

In the caulking joint method according to a fourth aspect, the hardness of the first component is higher than the hardness of the second component.

In the caulking joint method according to a fifth aspect, the second component is a housing that has a fluid passage where brake fluid flows, and the first component is an element of an electromagnetic valve that opens and closes the fluid passage.

In a caulking joint structure according to a sixth aspect, the caulking joint structure includes a first component made of metal that has a flange part on a perimeter, a second component made of metal that has a flange insertion hole where the flange part is inserted, and one end surface of the flange part is contacted to the bottom of the flange insertion hole.

Caulking load is applied around the flange insertion hole for plastic-deforming a portion around the flange insertion hole to cover another end surface of the flange part, and a part of a bottom of the flange insertion hole that faces the flange part has a form in which an outer circumference side is nearer to the flange part than an inner circumference side.

### BRIEF DESCRIPTION OF THE DRAWINGS

In the accompanying drawings:

FIG. 1 shows a sectional view of an actuator to which a caulking joint method in an embodiment of the present disclosure is applied;

FIG. 2 shows a sectional view of a form of a principal part of a housing before caulk-jointing;

FIG. 3A shows a sectional view of forms of principal parts of the housing and an electromagnetic valve before caulk-jointing;

FIG. 3B shows a sectional view of forms of principal parts of the housing and an electromagnetic valve before caulk-jointing in another embodiment; and

FIG. 4 shows a sectional view of the forms of the principal ₚarts of the housing and the electromagnetic valve after caulk-jointing.

### DETAILED DESCRIPTION OF THE PREFERRED EMBODIMENTS

With reference to the accompanying drawings, hereinafter will be described an embodiment of the present disclosure.

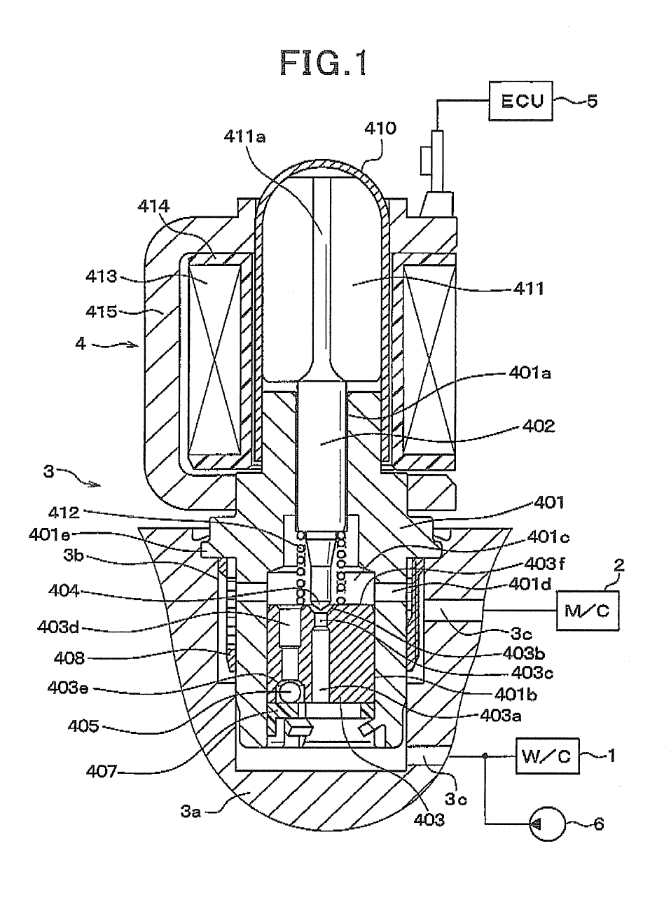

As shown in FIG. 1, between a wheel cylinder 1 (henceforth the W/C 1) and a master cylinder 2 (henceforth the M/C 2) of vehicles, an actuator for fluid pressure control 3 (henceforth the actuator 3) that controls brake fluid pressure is disposed.

The actuator 3 has a housing 3a made of an aluminum alloy.

A cylindrical recessed portion 3b with a step where an electromagnetic valve 4 is inserted and passages 3c for circulating brake fluid between the W/C 1 and the M/C 2 are formed in the housing 3a.

The electromagnetic valve 4 has a cylindrical guide 401 with a step formed by a magnetic metal, such as low carbon steel. One end of the guide 401 is inserted into the recessed portion 3b of the housing 3a and another end is projected outside the housing 3a.

The guide 401 is fixed fluid-tight to the housing 3a by caulking (or crimping) joint mentioned later.

In addition, the guide 401 corresponds to a first component of the present disclosure, and the housing 3a is corresponds to a second component of the present disclosure.

A guide hole 401a, a seat insertion hole 401b, and communication holes 401d are formed in the guide 401.

The guide hole 401a supports a shaft 402 slidably, a seat 403 is press-fit into the seat insertion hole 401b, and the communication holes 401d communicate with a space 401c that is a part of the seat insertion hole 401b to the M/C 2 side passage 3c.

In detail, the space 401c is a space bounded by the guide 401, the shaft 402, and the seat 403 among the seat insertion holes 401b.

The columnar shaft 402 is formed with a nonmagnetic material (for example, stainless steel). A seat 403 side end of the shaft 402 is extended to the space 401c projected from the guide hole 401a of the guide 401, and a sphere-shaped main valve body 404 is formed at a tip of the shaft 402.

A main passage 403a that communicates with the space 401c in the guide 401 and the W/C 1 side passages 3 is formed in a central part in a radial direction of the metal cylindrical seat 403.

A tapered main valve seat 403b where the main valve body 404 touches and separates is formed in a space 401c side end of the main passage 403a.

Moreover, an orifice 403c with a smaller passage sectional area than that of the main passage 403a is formed in the middle of the main passage 403a.

The main valve body 404 opens and closes between the space 401c in the guide 401 and the main passage 403a (or the communication holes 401d of the guide 401 and the M/C 2 side passage 3c) by separating from and touching to the main valve seat 403b.

A discharge port of a pump 6 is connected to the W/C 1 side passage 3c between the recessed portion 3b and the W/C 1.

Moreover, a sub passage 403d that communicates the space 401c in the guide 401 and the W/C 1 side passage 3c is formed in the seat 403 parallel with the main passage 403a and shifted from the central part in the radial direction of the seat 403.

In other words, the sub passage 403d bypasses the main passage 403a and is connected to the W/C 1 side passage 3c and the M/C 2 side passage 3c.

A tapered sub valve seat 403e is formed in the middle of the sub passage 403d.

A metal spherical sub valve 405 is inserted movably in the sub passage 403d at a side nearer to the W/C 1 side passage 3c than to the sub valve seat 403e.

The sub valve 405 opens and closes between the sub passage 403d and the W/C 1 side passage 3c by moving according to pressure difference and touches to and separates from the sub valve seat 403e.

Moreover, a spring receiving surface 403f that receives one end of a spring 412 (mentioned later) is formed in a space 401c side end of the seat 403 so as to surround the main passage 403a.

A filter 407 for preventing foreign substances to flow in is inserted in an opening end side of the seat insertion hole 401b of the guide 401.

A position of the sub valve 405 when the valve is opened is determined by the filter 407.

Moreover, another filter 408 for preventing foreign substances from flowing in is disposed on a perimeter of the guide 401 so as to surround the communication holes 401d.

A sleeve 410 is fitted to an outer surface of the other end of the guide 401.

The sleeve 410 is formed with a nonmagnetic material metal (stainless steel, for example), and has a closed-end cylindrical shape in which one end is opened, while a bottom is formed in a substantially globular shape.

A substantially columnar plunger 411 made of a magnetic metal is disposed in a space formed by the sleeve 410 and the guide 401 (henceforth the space in the sleeve), and the plunger 411 is disposed slidably in the sleeve 410.

In addition, upward movement of the plunger 411 in FIG. 1 is suppressed when the plunger 411 contacts the bottom of the sleeve 410.

A plunger slot 411a that extends continuously from one end to another end of the plunger 411 is formed in an outer surface of the plunger 411.

A bottom of the sleeve 410 side space in the space in the sleeve and a space between facing surfaces of the plunger 411 and the guide 401 in the space in the sleeve are communicated by the plunger slot 411a.

A spool 414 is disposed around the sleeve 410. A coil 413 that forms a magnetic field when current is supplied is wound around the spool 414.

A yoke 415 that forms a magnetic-path component is disposed at a perimeter of the spool 414.

The plunger 411 is driven by an electromagnetic force generated by supplying current in the coil 413 from an ECU 5 (electrical control unit).

In addition, in order to perform ABS control etc. based on a movement condition of vehicles, etc., the ECU 5 controls a current supplying condition to the coil 413.

The shaft 402 is pushed to the plunger 411 side by the spring 412 sandwiched between the shaft 402 and the seat 403, and the shaft 402 and the plunger 411 are always in contact and operate together.

The spring 412 is a compressed coil spring, and pushes the plunger 411 and the shaft 402 to a direction in which the main valve body 404 separates from the main valve seat 403b, i.e., to a valve opening direction.

Moreover, the plunger 411 and the shaft 402 are pushed by the electromagnetic force generated by supplying current in the coil 413 to a direction in which the main valve body 404 approaches the main valve seat 403b, i.e., to a valve closing direction.

The main passage 403a is communicated to an inner space positioned inside the spring 412 among the space 401c in the guide 401.

The communication holes 401d are communicated to an outer space positioned outside the spring 412 among the space 401c in the guide 401.

Next, a fundamental operation of the electromagnetic valve 4 having a composition mentioned above is explained.

The electromagnetic valve 4 is usually in the state where current is not supplied from the ECU 5 to the coil 413, i.e., in a disconnected state.

When in the disconnected state, the shaft 402 and the plunger 411 are pushed toward the bottom side of the sleeve 410 by the spring 412, and the plunger 411 is in contact with the bottom of the sleeve 410.

The main valve body 404 of the shaft 402 is separated from the main valve seat 403b of the seat 403, and between the W/C 1 side passage 3c and the M/C 2 side passage 3c are in a communicated state through the main passage 403a of the seat 403, the space 401c in the guide 401, and communication holes 401d of the guide 401.

When the pump 6 operates under this condition, the sub valve 405 is moved toward the sub valve seat 403e side of the seat 403 by the pressure difference of the W/C 1 side and the M/C 2 side, and the sub valve 405 contacts to the sub valve seat 403e so that the sub passage 403d of the seat 403 is closed.

Therefore, when the pump 6 operates, brake fluid flows from the W/C 1 side to the M/C 2 side only through the main passage 403a among the main passage 403a of the seat 403 and the sub passage 403d.

When the operation of the pump 6 is stopped, the sub valve 405 is moved by the pressure difference of the W/C 1 side and the M/C 2 side, and the sub valve 405 becomes separated from the sub valve seat 403e of the seat 403.

Between the W/C 1 side passage 3c and the M/C 2 side passage 3c becomes communicated through the sub passage 403c1 of the seat 403, the space 401c in the guide 401, and communication holes 401d of the guide 401.

Therefore, when the operation of the pump 6 is stopped, brake fluid may be promptly returned to the W/C 1 side from the M/C 2 side through the main passage 403a and sub passage 403d of the seat 403.

When a boost of the W/C 1 by the operation of the pump 6 is needed, the ECU 5 closes the main passage 403a by supplying current to the coil 413 while operating the pump 6. Thereby, a W/C pressure rises.

An amount of difference pressure generated between the upstream and downstream of the electromagnetic valve 4 according to the amount of current flowed to the coil 413 is adjusted linearly.

Thereby, W/C pressure is controlled according to the amount of current supplied to the coil 413.

Next, a composition of a caulk-joined part of the guide 401 and the housing 3a is explained.

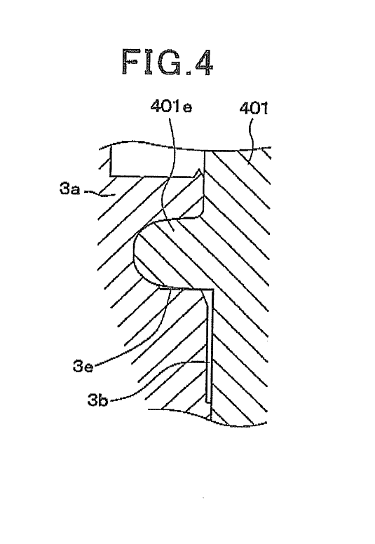

As shown in FIG. 1, FIG. 3A, and FIG. 4, the guide 401 of the electromagnetic valve 4 has a disk-shaped flange part 401e on its perimeter part.

The guide 401 is processed by machining or forging, and a perimeter edge of the flange part 401e has a rounded surface.

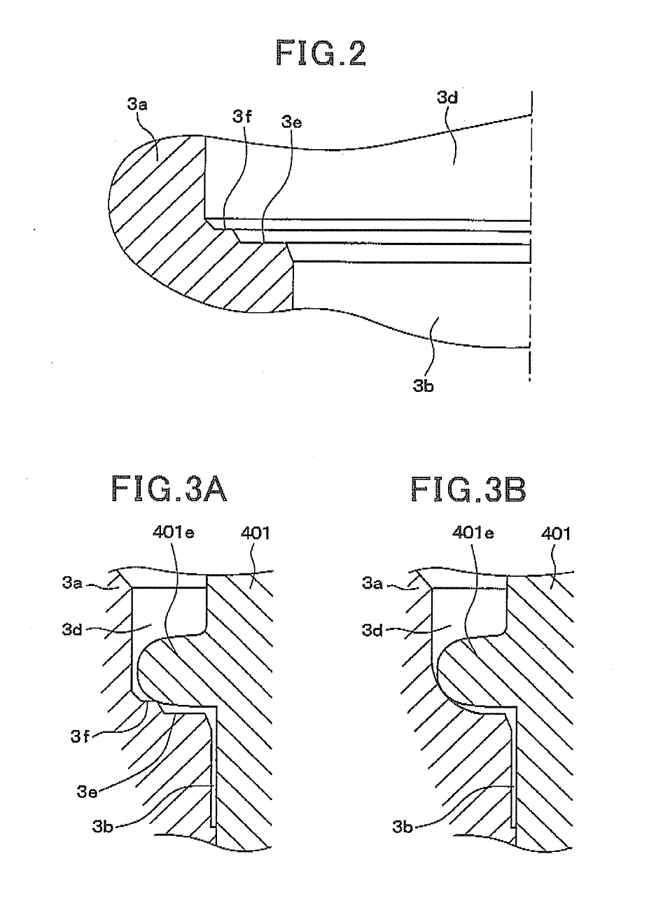

As shown in FIG. 2 and FIG. 3, a flange insertion hole 3d where the flange part 401e is inserted is formed in the housing 3a.

The flange insertion hole 3d is formed in an opening end side of the recessed portion 3b and has an inside diameter larger than that of the recessed portion 3b.

A part of the bottom of the flange insertion hole 3d that faces an end surface of the flange part 401e has a form in which an outer circumference side is nearer to the flange part 401e than an inner circumference side.

In detail, the bottom of the flange insertion hole 3d is formed into a stepped shape, and a first stepped surface 3e in the inner circumference side faces a flat surface of the flange part 401e.

Moreover, a second stepped surface 3f positioned in the outer circumference side than the first stepped surface 3e faces the rounded surface of the perimeter edge of the flange part 401e, and the second stepped surface 3f becomes closer to the flange part 401e than the first stepped surface 3e does.

The first stepped surface 3e and the second stepped surface 3f are formed by machining.

Next, a process of manufacturing a caulking joint of the guide 401 and the housing 3a is explained.

First, a main valve part (specifically, portion except the coil 413, the spool 414, and the yoke 415) of the electromagnetic valve 4 is prepared.

While inserting the one end of the guide 401 in the main valve part into the recessed portion 3b of the housing 3a, the flange part 401e is inserted in the flange insertion hole 3d.

In addition, contact conditions of the bottom of the flange insertion hole 3d and the flange part 401e in this moment can be considered as belonging to three patterns.

That is, a first pattern is a pattern that the flat surface of the flange part 401e contacts the first stepped surface 3e, and the rounded surface of the perimeter edge of the flange part 401e contacts the second stepped surface 3f.

A second pattern is a pattern that the rounded surface of the perimeter edge of the flange part 401e contacts the second stepped surface 3f, and the flat surface of the flange part 401e does not contact the first stepped surface 3e.

A third pattern is a pattern that the flat surface of the flange part 401e contacts the first stepped surface 3e, and the rounded surface of the perimeter edge of the flange part 401e does not contact the second stepped surface 3f.

Then, the housing 3a and the guide 401 are joined by applying caulking load around the opening end of the flange insertion hole 3d surrounded by the housings 3a, and a portion around the flange insertion hole 3d is plastic-deformed (refer to FIG. 4) so as to cover the other end surface of the flange part 401e.

When caulking load is applied further after the plastic-deformed portion contacts to the other end surface of the flange part 401e at this moment, the bottom of the flange insertion holes 3d is plastic-deformed because the hardness of the guide 401 is higher than the hardness of the housing 3a.

Here, when the flat surface of the flange part 401e contacts the first stepped surface 3e and rounded surface of the perimeter edge of the flange part 401e contacts the second stepped surface 3f like the first pattern mentioned above, since an area that receives caulking load is larger as compared with a case where only the flat surface of the flange part 401e contacts the bottom of the flange insertion hole 3d as before, the bottom of the flange insertion holes 3d can be prevented from buckling. moreover, when the rounded surface of the perimeter edge of the flange part 401e contacts the second stepped surface 3f and the flat surface of the flange part 401e is not contacted to the first stepped surface 3e like the second pattern mentioned above, the second stepped surface 3f is plastic-deformed and the flat surface of the flange part 401e also contacts the first stepped surface 3e, therefore the bottom of the flange insertion holes 3d can be prevented from buckling since the area that receives caulking load is increased relative to the prior art.

Furthermore, when the flat surface of the flange part 401e is contacts the first stepped surface 3e and the rounded surface of the perimeter edge of the flange part 401e does not contact the second stepped surface 3f like the third pattern mentioned above, the first stepped surface 3e is plastic-deformed and the rounded surface of the perimeter edge of the flange part 401e also contacts the second stepped surface 3f, therefore the bottom of the flange insertion holes 3d can be prevented from buckling since the area that receives caulking load is increased relative to the prior art.

In addition, although the buckling of the bottom of the flange insertion hole 3d can be prevented according to the present embodiment, the bottom of the flange insertion hole 3d after caulking may not maintain the stepped shape since the bottom of the flange insertion hole 3d slightly plastic-deforms.

### Other Embodiments

Although the part that faces the end surface of the flange part 401e among the bottoms of the flange insertion hole 3d is formed into the stepped shape in the above embodiment, this part may be formed into a curved shape, as shown in FIG. 3B, in which the outer circumference side is nearer to the flange part 401e than the inner circumference side.

Moreover, although the present disclosure is applied to the caulking joint of the guide 401 and the housing 3a in the actuator 3 for fluid pressure control in the embodiment mentioned above, the present disclosure may be applied to the caulking joint other than the guide 401 and the housing 3a in the actuator 3 for fluid pressure control.

Specifically, the present disclosure may be applied to the caulking joint of the housing 3a and a pressure sensor that detects brake fluid pressure, or to the caulking joint of the housing 3a and a plug of a fixed capacity damper that eases pulsation of the brake fluid that the pump discharges.

Furthermore, although the present disclosure is applied to the caulking joint of two components in the actuator 3 for fluid pressure control in the embodiment mentioned above, the present disclosure may be applied also to the caulking joint of two components in apparatus other than the actuator 3.

What is claimed is:

1. A caulking joint method for joining a first component made of metal that has a flange part on a perimeter and a second component made of metal that has a flange insertion hole where the flange part is inserted comprising:
forming a part of a bottom of the flange insertion hole that faces the flange part in which an outer circumference side is nearer to the flange part than an inner circumference side;
contacting one end surface of the flange part to the bottom of the flange insertion hole; and
applying caulking load around the flange insertion hole for plastic-deforming a portion around the flange insertion hole to cover another end surface of the flange part.

2. The caulking joint method according to claim 1, wherein,
the part of the bottom of the flange insertion hole that faces the flange part is formed into a stepped shape.

3. The caulking joint method according to claim 1, wherein,
the part of the bottom of the flange insertion hole that faces the flange part is formed into a curved shape.

4. The caulking joint method according to claim 1, wherein,
the hardness of the first component is higher than the hardness of the second component.

5. The caulking joint method according to claim 1, wherein,
the second component is a housing that has a fluid passage where brake fluid flows, and
the first component is an element of an electromagnetic valve that opens and closes the fluid passage.

6. A caulking joint structure comprising:
a first component made of metal that has a flange part on a perimeter;
a second component made of metal that has a flange insertion hole where the flange part is inserted;
one end Surface of the flange part is contacted to a bottom of the flange insertion hole;
caulking load is applied around the flange insertion hole for plastic-deforming a portion around the flange insertion hole to cover another end surface of the flange part; and
a part of the bottom of the flange insertion hole that faces the flange part has a form in which an outer circumference side is nearer to the flange part than an inner circumference side.

7. The caulking joint structure according to claim 6, wherein,
the second component is a housing that has a fluid passage where brake fluid flows, and
the first component is an element of an electromagnetic valve that opens and closes the fluid passage.
